(19) United States
(12) Patent Application Publication
(10) Pub. No.: US 2011/0261190 A1
(43) Pub. Date: Oct. 27, 2011

(54) DEFECT OBSERVATION DEVICE AND DEFECT OBSERVATION METHOD

(76) Inventors: Ryo Nakagaki, Kawasaki (JP); Minoru Harada, Fujisawa (JP); Kenji Obara, Kawasaki (JP)

(21) Appl. No.: 13/122,160

(22) PCT Filed: Sep. 28, 2009
(86) PCT No.: PCT/JP2009/067293

§ 371 Date: Jul. 15, 2011

(30) Foreign Application Priority Data
Oct. 1, 2008 (JP) 2008-255902

(51) Int. Cl. H04N 7/18

(52) U.S. Cl. 348/126

(57) ABSTRACT

A review SEM is provided with a means to store sets of images acquired using multiple imaging conditions or sets of images for which multiple imaging conditions are simulated using simulation, a means to store defect position information for each set of images, and a means to store information relating to imaging conditions and process time. A means to estimate predicted capture rate and throughput with the individual imaging conditions for the sets of images from the stored information, and a means to display the results thereof are additionally provided.

### TECHNICAL FIELD

The present invention relates to a technique of a defect observation device and defect observation method for observing images of defects and the like occurring in the production process of semiconductor wafers and the like. More particularly, the present invention relates to a technique for facilitating the setting of conditions for automatic observation.

### BACKGROUND ART

Circuit patterns formed on semiconductor wafers have been increasingly miniaturized, and the influence of defects occurring in the production process on the yield becomes more obvious. Under these circumstances, process control is increasingly important to prevent defects from occurring in the production stage. Currently, a wafer inspection device and an observation device (a review tool) are used in the production filed of semiconductor wafers to control the yield. The inspection device is a device for checking the presence or absence of a defect on a wafer at high speed. At this time, images of the state of the wafer surface are acquired by optical means (a bright-field wafer inspection device or a dark-field wafer inspection device) or electron beam. Then, the acquired images are processed to determine whether there is a defect. High speed is an important requirement for the inspection device. In order to satisfy this requirement, the inspection device acquires images with as large a pixel size as possible (namely, with a low resolution) to reduce the amount of image data. In many cases, it is possible to confirm the presence of a defect from the detected low resolution images, but it is difficult to determine in particular the type of the defect.

On the other hand, the review tool is a device for acquiring and observing images with the pixel size being reduced (namely, with a high resolution) with respect to each defect detected by the inspection device. In the production process of highly miniaturized semiconductor devices, the size of the defect to be inspected and observed is sometimes on the order of several tens of nanometers. In order to observe and classify the defect with a high accuracy, a resolution of nanometer order is necessary. Thus, in recent years a review tool using a scanning electron microscope (hereinafter referred to as a review SEM) has been widely used.

The recent defect inspection device has a high detection sensitivity and can detect a large number (several hundreds to several thousands, or sometimes to several millions) of defects are detected from a single wafer. As a result, the need for efficiency in the review operation to observe the detected defects has increased more than before. In order to meet this need, many of the review SEMs (Scanning Electron Microscopes) recently introduced into the market are provided with a function for automatically acquiring images of the defect portion detected by the inspection device, or ADR (Automatic Defect Review), as well as a function for classifying the acquired images, or ADC (Automatic Defect Classification).

An example of the automatic image acquisition and automatic defect classification functions of the convention review SEM are disclosed in Patent document 1. Patent document 1 describes the configuration of the review SEM, the automatic image acquisition and automatic defect classification functions, the operation sequence of the functions, the display method of the acquired images and classification results, and the like.

Patent document 1: JP-A No. 331784/2001

### DISCLOSURE OF THE INVENTION

### Problem to be Solved by the Invention

First, a brief description will be given of the automatic defect image acquisition function in the review SEM described above. Next, the problems to be solved by the invention will be described.

The automatic defect image acquisition function of the review SEM is a function for acquiring images of different portions of a wafer to be observed, from the input of defect position information obtained as a result of the defect inspection of the particular wafer by the inspection device as described above. The basic sequence of the function is as follows:
(1) Shift of the stage on which the sample is placed so that the defect desired to be observed comes into the field of view of the review SEM, based on the position information of the defect detected on the sample by the inspection device; and
(2) Image acquisition of the defect portion by the review SEM with a high magnification of about 50 thousands to 200 thousands times.
   The function is realized by repeatedly applying these processes to each defect.

However, it is necessary to take into account the coordinate error of the inspection device in the image acquisition of the defect portion. In general, the inspection device may include a coordinate error of about several micrometers to several tens of micrometers. In this case, if the inspection device directly images at the defect coordinate position with a high magnification of, for example, 50 thousand to 200 thousand times, the defect may not come into the field of view of the inspection device. The approach for this case includes the following steps. First, take an image of the area in which a defect is expected to be present by the review SEM with a wide field of view (FOV) (for example, 15 μm to 10 μm). Next, detect the position of the defect by applying image process to the image. Then, take an image with a narrow field of view (for example, 10 μm to 4 μm) so that the detected position is located at the center of the field of view. In this case, the image acquisition is performed twice by the review SEM in the basic sequence as described above.

Further, as a method for achieving the defect position detection in the above sequence, there is a method for comparing an image (reference image) in which no defect is present, with an image (defect image) taken in the defect portion. Semiconductor wafers are produced by repeatedly forming the same circuit pattern on each chip. Thus, in general, the above comparison method is applied to detect a defect position on each chip by using a reference image which is an image taken in the adjacent chip in the portion corresponding to the defect portion on the particular chip. In this case, it is necessary to perform the imaging process of the reference image and to perform the stage shift for the imaging process, in addition to the above sequence. It is to be noted that the image quality control process, such as auto focus control and auto brightness control, is also necessary for the image acquisition.

As described above, the image acquisition is performed a plurality of times for a single defect such as in the sequence of acquiring the reference image other than the defect image, and in the sequence of acquiring defect images with two different types of field of view. At this time, the image quality control process may be necessary for each image acquisition.

Throughput is an important performance index for the automatic defect image acquisition function. The higher the throughput, the more defects can be observed per unit time. For this reason, high throughput is expected to increase the accuracy of understanding the defect occurrence state and the accuracy of determining countermeasures. In order to increase the throughput, it is necessary to reduce the time for the stage shift, the time for the image quality control function such as auto focus control, and the time for the image acquisition itself.

There are various approaches for reducing the image acquisition time. For example, the number of images used for image averaging is reduced. The SEM image has a lot of shot noises and has a low S/N ratio. Thus, in general, the review SEM acquires a plurality of images of the same portion, and averages the images to acquire an image with a high S/N ratio. If the number of images for the image averaging is reduced, the process time is reduced. Another effective approach for reducing the imaging operation time is to increase the current amount of electron beam current (hereinafter probe current) that is irradiated onto the sample. When the probe current is large, it is possible to acquire an image with a higher S/N, even if the averaging number is the same. Further, when the image size (the number of pixels) is reduced, it is expected to reduce not only the time for the image acquisition itself, but also the image process time as well as the time for transferring and storing images within the system. As a result, it is effective in increasing the throughput.

However, from the point of view of the defect detection process for the images acquired with a low magnification (namely, a wide field of view), the above approaches such as the reduction in the number of images to be averaged, the increase in the probe current, and the reduction in the image size may act in a direction that makes the detection more difficult. For example, the reduction in the number of images means that the defect detection must be performed from images with a lower S/N. As a result, the risk of false detection of noise as a defect increases.

Further, the increase in the probe current may lead to the risk of charging occurring on the sample surface, or the risk of contamination deposition on the sample by electron beam irradiation. In this case, a brightness difference occurs in the image even in the portion other than the defect portion. In this case, the normal portion is more likely to be falsely detected as the defect portion. Further, when the field of view of the imaging area is fixed, the reduction in the image size is equal to the increase in the pixel size, making it difficult to automatically detect defects of a size near or less than the pixel size. As a result, missing of micro defects is more likely to occur.

As described above, the change of the imaging conditions for the purpose of improving the throughput may increase the risk of reducing the capture rate. The relationship between the throughput and the capture rate is different depending on the process and type of the wafer to be inspected. Practically, it depends on the manual operation of an operator to determine the imaging conditions that satisfy both the throughput and the capture rate. As a result, a huge amount of time is required for the operation in a high-mix low-volume production line, and the like, in which frequent condition setting is necessary.

The object of the present invention is to solve the above problems by providing a defect observation method and defect review tool that can satisfy high throughput and high detection performance requirements.

### Means for Solving Problem

In order to achieve the above object, an aspect of the present invention relates to a review SEM. The review SEM includes a means to store sets of images acquired with a plurality of imaging conditions, a means to store defect position information for each set o images, and a means to store the relationship candidate setting values for each of the parameters that constitute the imaging conditions, and process times for setting the individual candidate values. The parameters include optical parameters such as acceleration voltage and probe current, as well as imaging parameters such as image size and averaging number, and the like.

Further, the review SEM includes a means to set a plurality of imaging conditions by combining the candidate values for each of the individual parameters that constitute the imaging conditions, and a means to estimate the capture rate and the throughput performance with respect to the plurality of imaging conditions. Still further, the review SEM also includes a means to automatically select one or more imaging conditions from the plurality of imaging conditions, based on the capture rate and the throughput value. In addition, the review SEM has a function of displaying the capture rate and the throughput value that are calculated for each of the plurality of set imaging conditions, and have a function of selectively displaying the imaging condition automatically selected from the plurality of set imaging conditions.

### Effect of the Invention

According to the present invention, it is possible for a user to easily understand the relationship between the content of the condition setting and the two performance indexes of the capture rate and the throughput performance, which vary depending on the various conditions of the automatic image acquisition function set in the device. As a result, the user can easily set conditions for automatic review.

### BRIEF DESCRIPTION OF THE DRAWINGS

FIG. 1 is a block diagram of a defect review tool according to a first embodiment of the present invention;

FIG. 2 is a block diagram of an imaging unit of the defect observation system;

FIG. 3 is a flow chart of the defect image acquisition process;

FIG. 4 is a flow chart of the imaging condition evaluation method according to the first embodiment of the prevent invention;

FIG. 5 is a view showing an example of the imaging condition parameter list;

FIG. 6 is a front view of an instruction screen of defect information according to the first embodiment of the present invention;

FIG. 7 is a view showing an example of the relationship between candidate values for each of the imaging condition parameters, and process times for the individual candidate values;

FIG. 8 is a front view of an example of the screen displaying the imaging condition evaluation results;

FIG. 9 is a front view of another example of the screen displaying the imaging condition evaluation results;

FIG. 10 is a block diagram of a defect review tool according to a second embodiment of the present invention;

FIG. 11 is a flow chart of the imaging condition evaluation method according to the second embodiment of the present invention;

FIG. 12 is a view showing an example of the imaging condition parameter list; and

FIG. 13 is a front view of an example of the screen displaying the imaging condition evaluation results according to a third embodiment.

### EXPLANATIONS OF LETTERS OR NUMERALS

101: imaging unit
102: overall control unit
103: input/output unit
104: recipe storage unit
105: evaluation image storage unit
106: recipe evaluation unit
107: process time data storage unit
108: defect detection execution unit
109: capture rate calculating unit
110: throughput calculating unit
201: sample
202: stage
203: electron source
204: electron beam
205: condenser lens
206: aperture
207: objective lens
208: detector
209: deflector
210: image storage unit
601: thumbnail portion
602: instruction area
603: defect portion
604: defect definition area
606: defect information input unit
1001: reference image storage unit
1002: image generation unit
1003: imaging condition generation unit
1004: determination unit
1005: simulator

### BEST MODE FOR CARRYING OUT THE INVENTION

Hereinafter embodiments of a defect observation method according to the present invention will be described in detail.

### First Embodiment

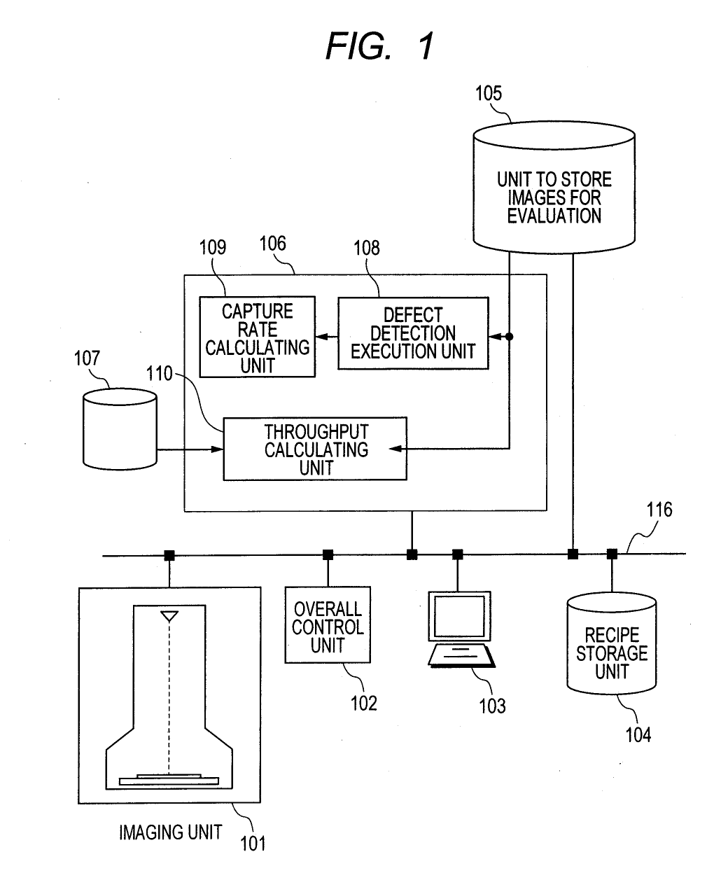

FIG. 1 is a block diagram of a defect review tool according to the present invention. The device includes an imaging unit 101, an overall control unit 102, an input/output unit 103, a recipe storage unit 104, an evaluation image storage unit 105, a recipe evaluation unit 106, and a process time data storage unit 107. More specifically, the imaging unit 101 acquires defect images, and has a function of acquiring images of a local area of a sample. The overall control unit 102 controls the entire device. The input/output unit 103 has a function of inputting various commands to the device and displaying processed results and the like. The recipe storage unit 104 stores various setting conditions (recipes) to perform automatic acquisition function. The evaluation image storage unit 105 stores images for evaluation used in the setting of the recipes. The recipe evaluation unit 106 evaluates the defect detection rate and the throughput with respect to the recipe to be set. The process time data storage unit 107 stores process time data necessary for estimating the throughput that varies according to the set condition. In the following description, the embodiment assumes that a scanning electron microscope (SEM) is used as the imaging unit. However, the present invention is not limited to this example, and the imaging unit may be an optical defect image acquisition means.

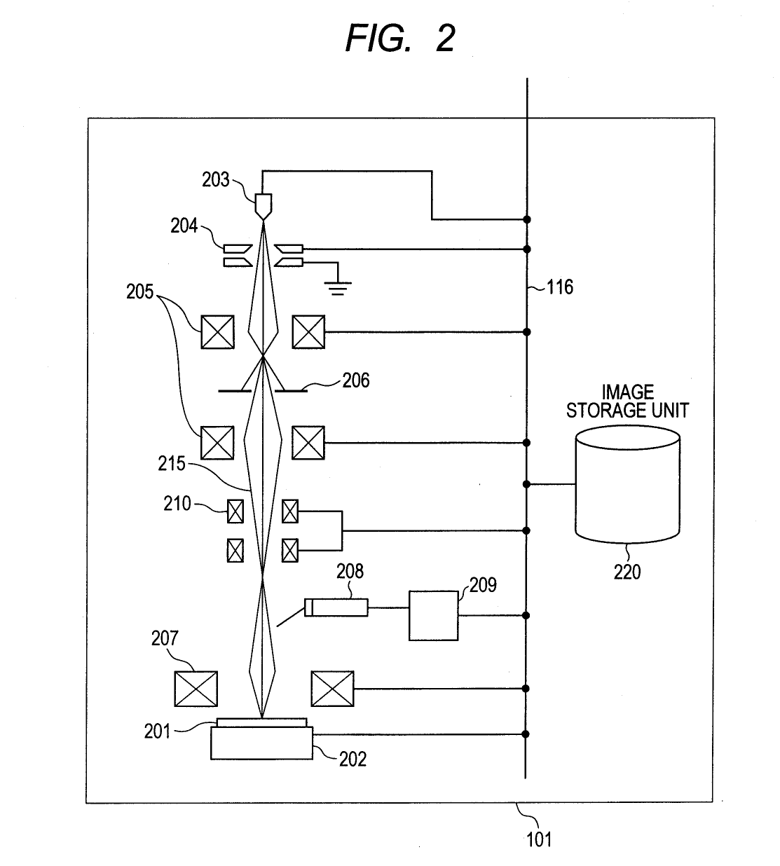

FIG. 2 is a view showing a configuration example of the imaging unit 101 using the SEM. A sample wafer 201 is placed on a movable stage 202. An electron beam 215 is extracted from an electron source 203 and accelerated by lead electrodes 204. The electron beam 215 is focused by condenser lenses 205, an aperture 206, and objective lenses 207, and is incident onto the surface of the sample. Secondary electrons or reflective electrons generated from the sample surface are detected and photoelectrically converted by a detector 208. Then, the amount of the detected electrons is converted to digital data by an analog-digital (A/D) converter 209 or other means. The electron beam 215 is two-dimensionally scanned on the sample by a deflector 210 to acquire two-dimensional digital images of the sample. The acquired images are stored in an image storage unit 220. Each of the components is connected to the overall control unit 102 through a bus 116.

In this device, changing the area (the field of view) to be scanned by the deflector 210 means changing the field of view in the image acquisition, which is equivalent to changing the magnification. Further, in the analog-digital (A/D) converter 209 for converting to a digital signal, the magnitude of the conversion clock interval (sampling interval) corresponds to the magnitude of the image size of the digital image to be acquired. For example, the reduction in the sampling interval is equal to the reduction in the image size even with the same field of view. In this case, smaller defects can be imaged. Such various setting conditions for image acquisition, as well as the optical conditions (the acceleration voltage of the electron beam 204 to be irradiated, the amount of current (probe current), and the like) for other image acquisitions, are set by instructions from the overall control unit 102 through the bus 116.

Next, a description will be given of the process step of the automatic defect image acquisition function executed by the device shown in FIG. 1, and the parameter content (recipe content) of the condition setting to be set. A description will also be given of two performance indexes (capture rate and throughput) that must be taken into account in the condition setting.

Here, the defect image acquisition function is a function for automatically acquiring images of a defect present on the sample, or images of the area in which a defect may occur by using the imaging unit 101. The coordinates of the defect to be imaged are input from the outside. More specifically, the coordinates of the defect are given by a defect inspection device for the purpose of obtaining the position of the defect on the sample, or by a lithography simulator or other means. The lithography simulator estimates the shape of the circuit pattern formed on the sample, and identifies the area in which a pattern different from the desired pattern may be formed.

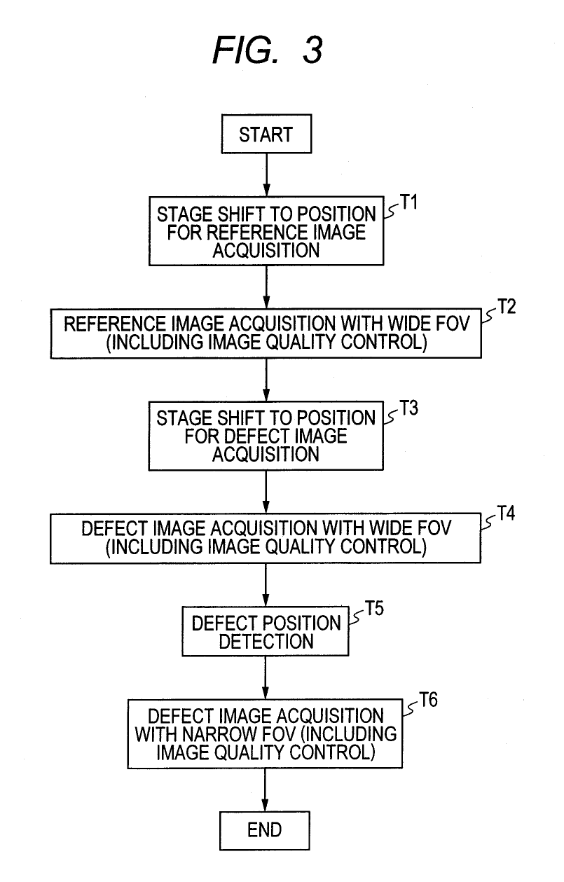

FIG. 3 shows the steps of the image acquisition. The figure shows, as an example of the image acquisition sequence, the steps of acquiring three different images of a certain defect based on the defect coordinates given by the defect inspection device. The three images are a wide field-of-view image including the defect portion, a wide field-of-view image of the reference portion in which the same circuit pattern as that in the defect area is expected to be formed, and a narrow field-of-view image of the defect area.

In the flow shown in FIG. 3, first the process shifts the stage to the position so that the reference portion comes into the field of view of the imaging unit (T1). Next, the process acquires a wide field-of-view image of the reference portion (for example, the field of view size is several tens of micrometers in the vertical and horizontal directions) (T2). At this time, when the defect is detected by die comparison, the reference portion is located at the position shifted by one chip with respect to the defect coordinates. In addition, the process includes an image quality control process such as auto focus control and image brightness control, in order to acquire a clear and high quality image. Then, the process shifts the stage to the position so that the defect portion comes into the field of view of the imaging unit (T3). Next, the process acquires a defect image with a wide field of view (T4). Then, the process detects the defect portion by comparing the two images acquired with the wide field of view (T5). Then, the process acquires a defect image with a narrow filed of view (for example, the field of view size is several micrometers in the vertical and horizontal directions) with respect to the detected position (T6). The above is the imaging sequence for a single defect. The above processes are performed sequentially with respect to a plurality of defects on the wafer.

The purpose for acquiring the reference image is, as described above, that the defect position is detected by comparing the wide field-of-view defect image with the reference image. The semiconductor circuit pattern includes a portion in which the same circuit pattern is repeatedly formed, for example, in a memory cell unit of a flash memory device. In the case of the repeated pattern, it is possible to synthesize the reference image from the defect image taken in the portion including the defect by using the repeatability of the circuit pattern, instead of using a method of taking the image in the normal portion of the semiconductor circuit pattern shifted by one chip with respect to the defect coordinates. In this way, the position of the defect can be detected by comparing the wide field-of-view defect image with the reference image synthesized from the particular defect image. Thus, if it is possible to determine in advance in any way that a defect occurs in the repeated pattern portion such as the memory cell portion, the reference image acquisition and the associated stage shift are not necessary. It is to be noted that in this embodiment, the two images of different field of views (wide and narrow field of views) are acquired. This is because, as described above, acquiring the narrow field-of-view image alone may not ensure that the defect is included in the particular field of view due to the defect coordinate error, and the stage shift error or other factors.

From the process sequence of the automatic image acquisition described above as well as the aforementioned imaging principle of the review SEM, the process parameters to be set for achieving the automatic defect image acquisition function include the following five items.

(1) Acceleration voltage

(2) Probe current

(3) Number of images to be averaged (for each of the wide and narrow field-of-view images)

(4) Image size (for each of the wide and narrow field-of-view images)

(5) Field of view size (for each of the wide and narrow field-of-view images)

These condition values must be stored in the recipe storage unit 104 as recipes prior to the automatic image acquisition.

In the automatic defect image acquisition function, the capture rate and the throughput are the important performance indexes. The capture rate means the accuracy of the process of detecting the defect position from the wide field-of-view defect image. If the portion other than the defect portion is falsely detected as a result of a failure of the defect detection, it is quite natural that the narrow field-of-view image of the portion is meaningless. For this reason, in general, defect detection rate of 95% or more is required.

Another important performance index in the automatic defect image acquisition is throughput. The throughput is the number of defects in image acquisition per unit time. In order to improve the throughput, it is necessary to reduce the process time in each of the steps shown in FIG. 3. More specifically, it is necessary to reduce the time for the image acquisition with wide and narrow field of views, the time for the stage shift, the time for the defect detection process, and the time for other image quality control processes.

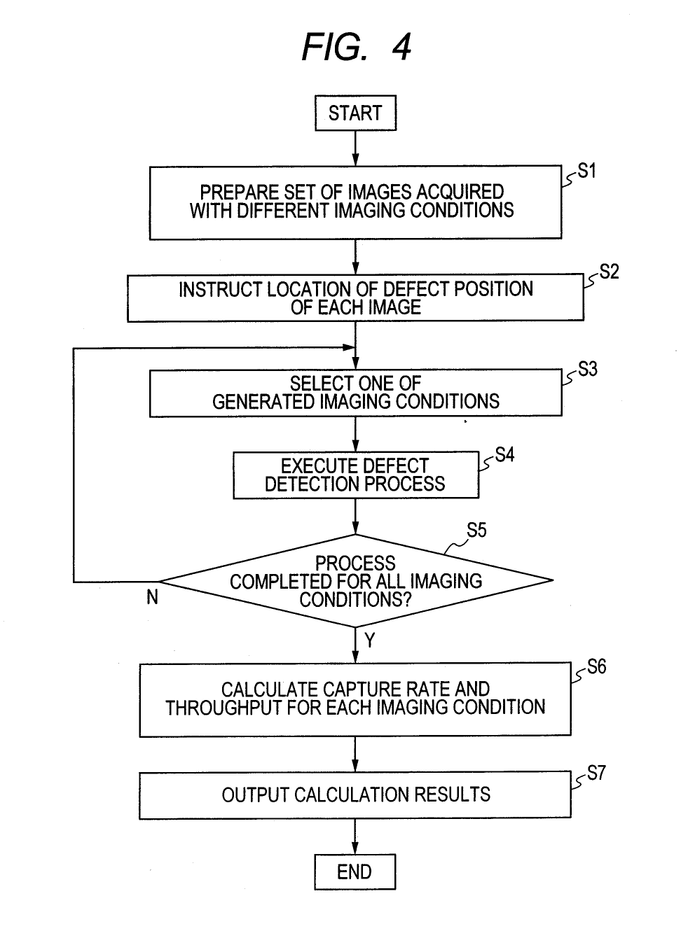

Next, the recipe setting method according to the present invention will be described. FIG. 4 shows a process flow. First, the process acquires image data acquired with a plurality of sets of imaging conditions including the process parameters of (1) to (5) with different setting values. Then, the acquired image data is stored in the evaluation image storage unit 105 (S1).

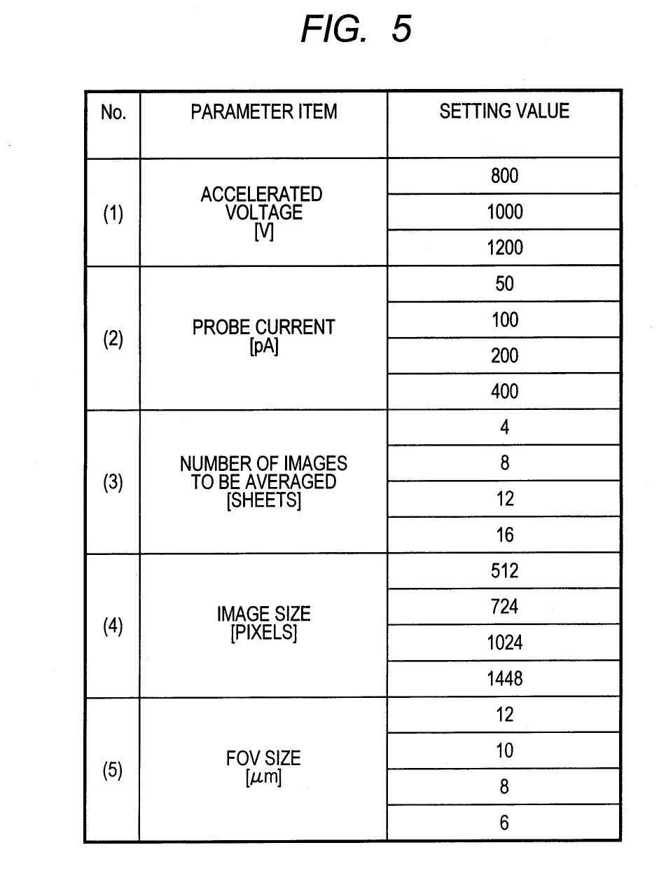

One specific implementation of this step is as follows. First, list data shown in FIG. 5 is stored in a table format in the evaluation image storage unit 105. The list data includes candidate setting values for each of the parameters. Then, the overall control unit 102 generates a plurality of sets of imaging conditions by combining the candidate values of the individual parameters. Then, the imaging unit 102 takes images based on the content of each set of imaging conditions.

In FIG. 5, an example of the content of the candidate setting values for the individual parameters is shown as follows: (1) acceleration voltage: 3 types, (2) probe current: 3 types, (3) averaging number: 4 types, (4) pixel size: 4 types, and (5) filed of view: 4 types. The number of candidate values of the individual parameters varies depending on the content to be set in the table. When the number of candidate values for each parameter is increased, the total number of combinations of the candidate values is explosively increased. Thus, in order to effectively reduce the acquisition time of the evaluation images, the types of the parameters are narrowed down in advance or the number of candidate values is reduced. The sample wafer is placed on the stage 202 in advance before image data acquisition. The overall control unit 102 instructs the imaging unit 101 to acquire images in the process step shown in FIG. 3, based on the imaging conditions generated by combining the candidate values of the individual parameters as described above. The practical number of defects to be imaged is in the range of several defects to several tens of defects. However, the present invention is not limited to this example. The acquired images are stored in the image storage unit 210.

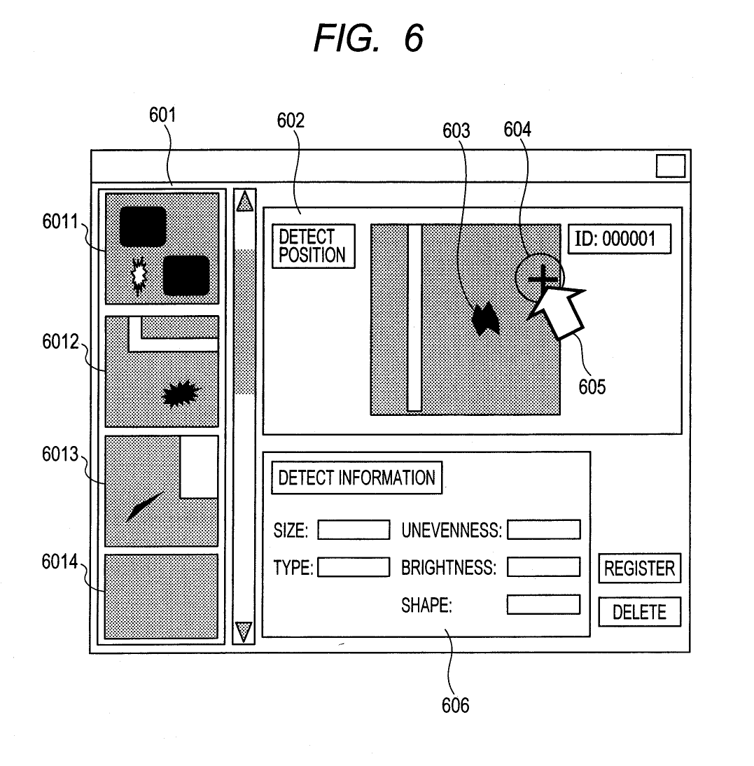

Next, with respect to the wide field-of-view defect images of the acquired evaluation image data, the position of the defect portion in each image is instructed on the input/output unit 103 (S2). FIG. 6 shows an example of the display screen of the input/output unit 103 that executes the instruction process. A thumbnail portion 601 is an area in which the acquired defect images are displayed in thumbnail. Of the acquired images of the sample wafer, the image data acquired with the same imaging condition are read from the image storage unit 210. Then, the list of the read image data is displayed in the thumbnail portion 601. In FIG. 6, defect images 6011 to 6014 are shown as an example. In this area, an arbitrary image is selected from 6011 to 6014 by using a mouse cursor 605. Then, the enlarged view of the selected image is displayed in an instruction area 602.

In the instruction area 602, the position of a defect portion 603 of the image displayed on the screen is registered by using the mouse cursor 605. More specifically, a defect definition area 604 is defined and registered by using the mouse cursor 605 on the screen. In this case, the defect definition area 604 means the center of the defect (indicated by the cross in the figure) and the range of the defect (indicated by the circle in the figure). The image selection in the thumbnail portion 601 and the instruction process in the instruction area 602 are repeated to instruct for the acquired image data. The instructed image data is stored in the evaluation image storage unit 105.

It is assumed that the number of defects to be registered in the evaluation image data is N with respect to one set of imaging conditions that is set by selecting setting values for each of the parameter items (1) to (5), and that the number of sets of imaging conditions is M. In this case, the number of defects to be instructed is N×M. If M is large, it is not realistic to register all defects through the screen. In such a case, instead of instructing for all of the image data acquired by the imaging unit 101, it is possible to apply instruction data registered for the image data acquired with a certain imaging condition, to the image data acquired with the other imaging conditions.

The specific procedure is as follows. First, an ID is given to each defect on the sample in advance. Then, a set of N defect images is acquired from the sample wafer with one of imaging condition sets. Next, the defect positions for the individual N defect images are registered by using the method shown in FIG. 6. Then, images of the same defect are acquired with the other imaging conditions. At this time, the ID of the defect to be imaged must be the same as the ID of the defect previously imaged. The use of the ID makes it easy to select the same defect from the defect image data acquired with the other imaging conditions. Next, a non-instructed defect image is selected from the acquired defect image data, and the ID given to the defect is gotten. Then, a defect image corresponding to the given ID is acquired from the instructed defect image data.

As the two images of the same defect are acquired with different imaging conditions, it is natural that there is a difference in the image quality due to the difference in the imaging conditions. In general, there is also a slight field of view displacement due to the error in the stage stop accuracy or other factors. Thus, the field of view displacement between the instructed image and the non-instructed image of the same defect is detected by pattern matching. Then, the detected displacement is added to the defect position of the instructed defect image, in order to estimate the position of the defect on the non-instructed image. This estimation of the defect position is performed for M sets of images. As a result, the defect position can be located with respect to N×M defect image data by performing the instruction process only N times.

Next, one condition is selected from the imaging condition set (S3). The defect detection process is performed with respect to the image data set (N images) acquired with the selected condition (S4). This defect detection process is performed by a defect detection execution unit 108 of the recipe evaluation unit 106. The defect detection execution unit 108 stores a program for executing the defect detection process. Further, the defect detection execution unit 108 has a function of executing off-line the same process as the defect detection process (T5) executed in the process flow of FIG. 3 by using the stored program, with respect to the input wide field-of-view images. This defect detection process is performed for all of the N images of the image data set.

Next, using the result data of the defect detection process for the N images, the capture rate is calculated by a capture rate calculating unit 109 of the recipe evaluation unit 106 in the defect review tool shown in FIG. 1. At the same time, the throughput performance is calculated by a throughput calculating unit 110 of the recipe evaluation unit 106, based on the currently selected imaging condition (S5). This process is performed for all of the M sets of imaging conditions.

In the calculation of the capture rate, the capture rate calculating unit 109 compares the detect detection position of the process result in the detect detection execution unit 108, with the instructed detect detection position. Then, the capture rate calculating unit 109 evaluates the difference between the two defect positions. For example, when the defect detection position is located within the circle 604 which is the area defined in the instruction, it is determined that the defect detection is successful or otherwise failed. In this way, success or failure is determined for all of the N images of the defect image data set with the same imaging condition. Then, the ratio of the number of successes is calculated as the capture rate.

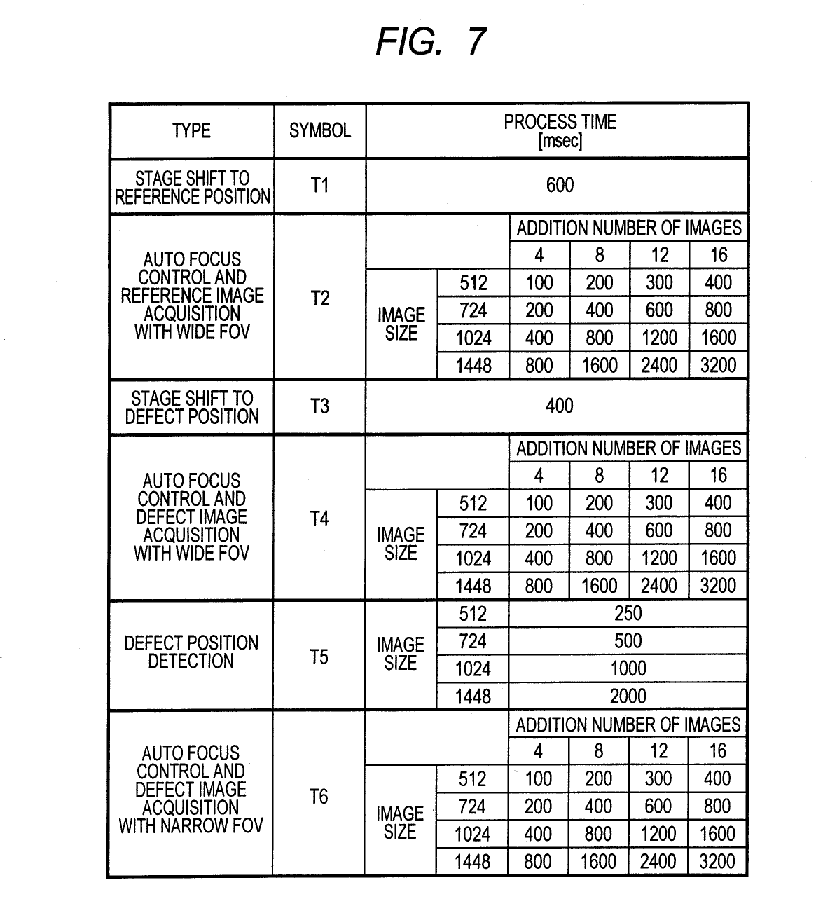

On the other hand, in the calculation of the throughput, function data is used for the process time stored in the process time data storage unit 107. FIG. 7 is an example of such process time data. A table shown in FIG. 7 displays the process time for each of the candidate values of the imaging condition parameters shown in FIG. 5, with respect to each of the process steps T1 to T6 of defect image acquisition shown in FIG. 3. Times for the processes T1 to T6 with respect to the currently selected imaging conditions are read from the values of the set parameters in the table shown in FIG. 7. Then, the six values a e summed to calculate the time for acquiring images of a single defect.

For example, it is assumed that the currently selected imaging conditions are as follows:
(1) Image size of reference image with wide field of view: 1024
Addition number of reference images with wide field of view: 8
(2) Image size of defect image with narrow field of view: 512
Addition number of defect images with narrow field of view: 16

In this case, T1 is 600 msec, T2 is 800 msec, T3 is 400 msec, T4 is 800 msec, T5 is 1000 msec, and T6 is 400 msec, respectively. Thus, the total process time is 4000 msec. This value is converted to a throughput of about 900. Here, the throughput is, for example, the number of defects that can be automatically observed for one hour.

The data of the individual process times shown in FIG. 7 are specific to the device. Thus, the data can be defined in advance. In this case, any values can be set as long as they are normal. For example, the time for the stage shift is the time necessary for the stage shift between the position of a certain defect portion, and the reference portion of the other defect. More precisely, although the value varies depending on the distance between the defects, namely, depending on the defect distribution, a general standard (for example, an average shift distance of 10 mm) is set. Then, the average time is shown based on the general standard.

Here, the throughput is estimated by the method of accumulating the individual process time data shown in FIG. 7. However, another method can also be used. For example, there is a method of measuring the time spent for image acquisition in the evaluation image acquisition process in step S1 so that the measured value is used as the throughput.

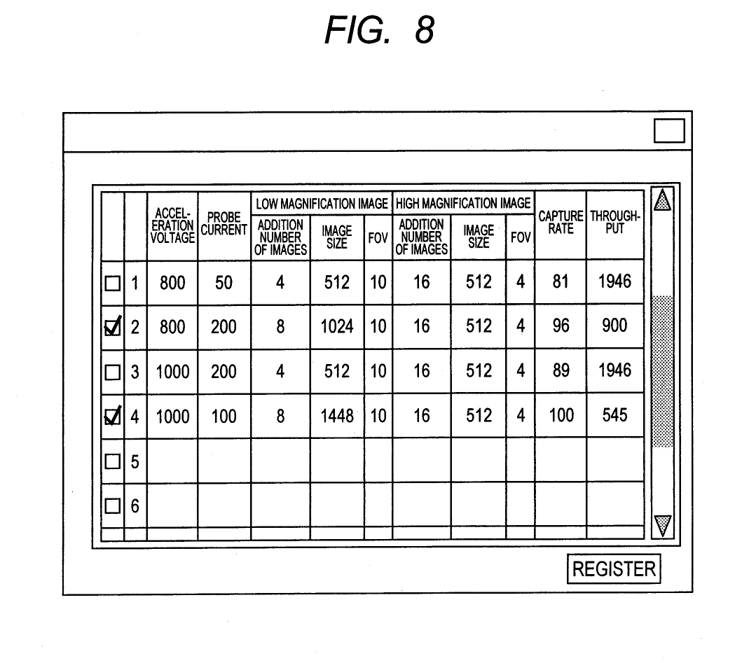

At last, the capture rate and throughput values calculated by the recipe evaluation unit 106 for different sets of imaging conditions are output to the input/output unit 103. FIG. 8 is an example of the display screen, in which the parameter values, the capture rate, and the throughput performance are displayed in a line for each set of imaging conditions. In this screen, the data can be sorted using an arbitrary parameter as a key to easily compare the values between different sets of imaging conditions. The user views the display results, selects a plurality of conditions (in checkboxes) to be actually used, and clicks the register button. In this way, the content of the selected condition setting is stored in the recipe storage unit 104.

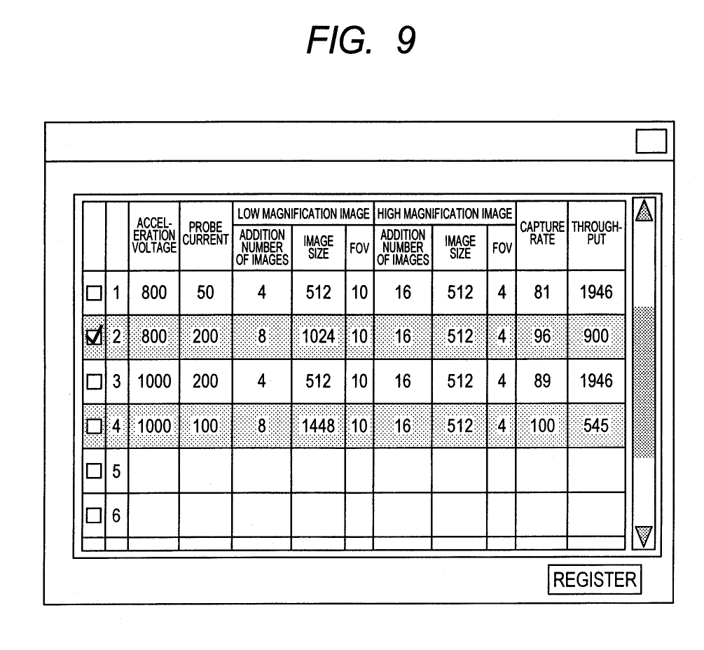

It is to be noted that in the above example, the condition setting registered in the recipe storage unit 104 is manually set on the display screen of the input/output unit 103. However, it is also possible to automatically determine the condition setting based on the criteria defined in advance by the recipe evaluation unit 106. For example, one of the criteria is “the capture rate of 95% or more for the imaging condition with the highest throughput performance”. In this case, as shown in FIG. 9, only the conditions satisfying the given criteria for the capture rate are highlighted in advance on the display screen (in the example of FIG. 9, the corresponding rows are displayed in gray). Then, the condition with the highest throughput of the highlighted conditions is automatically displayed with a check mark. This makes it easier for the operator to perform check operation. In this case, the operator can register the condition setting in the recipe storage unit after the check operation, or can automatically register the condition setting without performing the check operation. In both cases, as shown in FIG. 8, with respect to a plurality of imaging conditions, the two performance indexes of the capture rate and the throughput are displayed. Then, the conditions are selected and sorted based on the condition parameters and the performance indexes. With this function, it is possible to easily select imaging conditions suitable for particular automatic image acquisition.

### Second Embodiment

Next, a second embodiment of the defect observation method according to the present invention will be described.

In the first embodiment, the evaluation data used for evaluating the capture rate is acquired through the image acquisition in the imaging unit 101 under a plurality of sets of imaging conditions set in advance. In the description of the second embodiment, the review SEM according to the present invention has a function of generating evaluation data by simulation with the other imaging conditions using the acquired image data, instead of actually taking images to acquire all the evaluation image data as in the first embodiment.

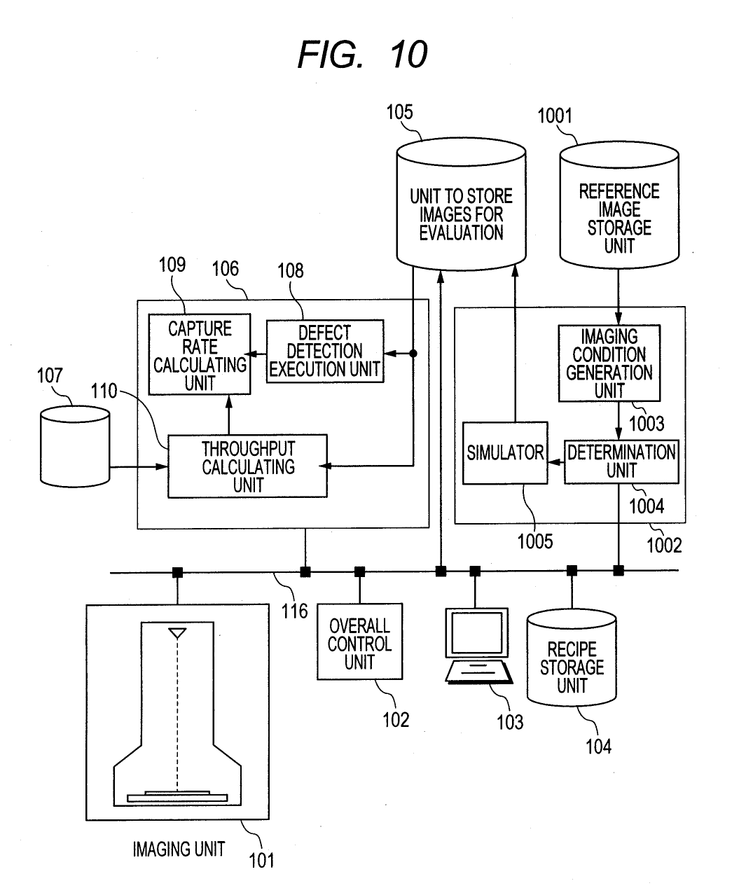

FIG. 10 shows the device configuration of the review SEM according to the second embodiment. In addition to the device configuration shown in FIG. 1, the review SEM also includes a standard image storage unit 1001 and an image generation unit 1002. The standard image storage unit 1001 stores a standard image as the base of image generation in association with the corresponding imaging conditions. The image generation unit 1002 generates an image by simulation from the standard image. Further, the image generation unit 1002 includes an imaging condition generation unit 1003, a determination unit 1004, and a simulator 1005. The imaging condition generation unit 1003 generates different imaging conditions based on the imaging conditions of the standard image. The determination unit 1004 determines whether it is necessary to perform image acquisition with the generated imaging conditions by the imaging unit, or whether it is possible to generate by simulation. The simulator 1005 generates images by simulation.

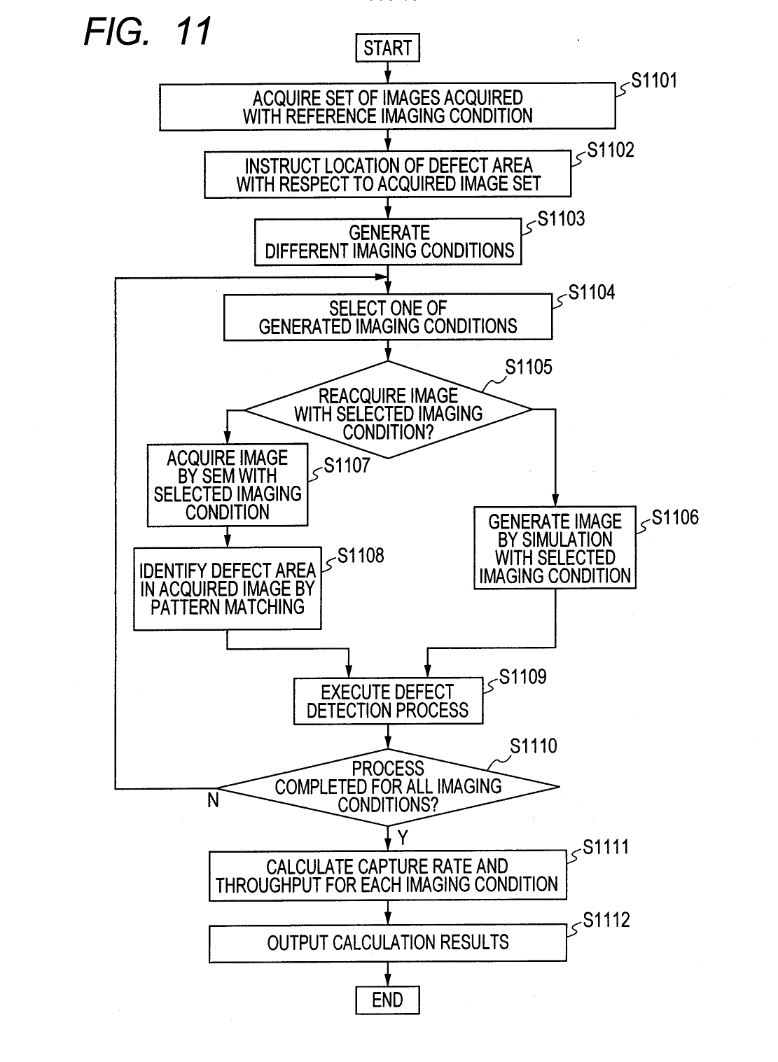

FIG. 11 shows a process flow according to the present invention. The process flow of the second embodiment is different from the process flow of the first embodiment shown in FIG. 4, in the acquisition method of a set of images with different conditions, and in the instruction flow in the defect area.

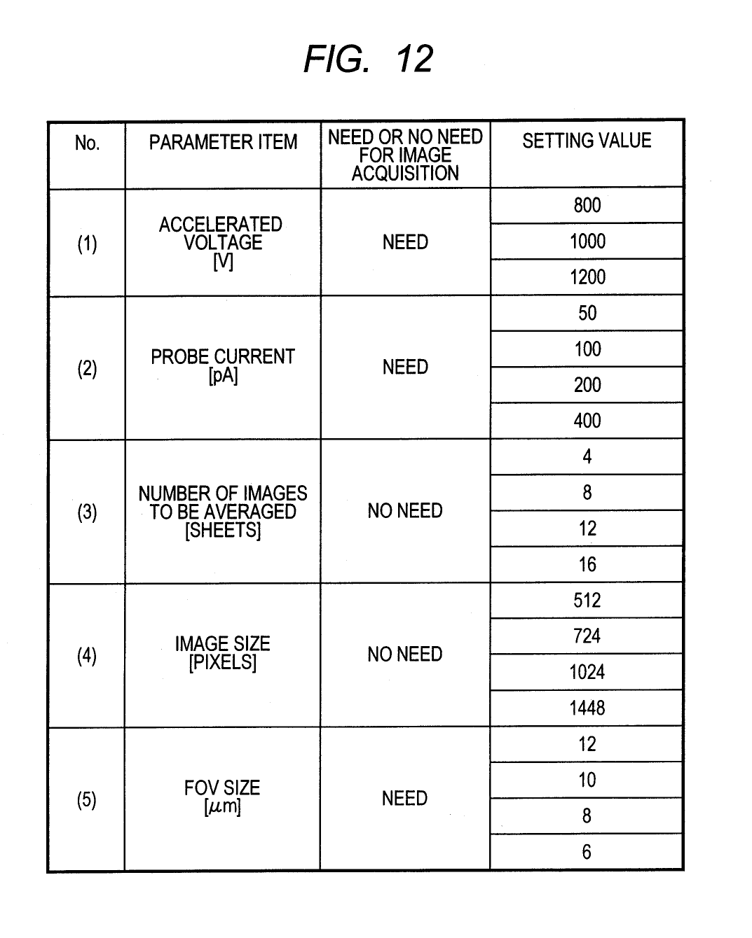

First, the process stores list data in the standard image storage unit 1001. The list data includes a list of setting value candidates for each of the parameters set as the imaging conditions, and information on whether image acquisition by the imaging unit is necessary to acquire images by changing the setting values for each of the parameters. FIG. 12 is an example of the list data. The parameters include the following five types: acceleration voltage, probe current, averaging number, image size, and field of view size. It is assumed that the five types of parameters have candidate setting values of 3, 4, 4, 4, 4 types, respectively.

FIG. 12 also shows “NEED” or “NO NEED” for the image acquisition with respect to each of the parameters. This shows whether it needs to reacquire images with the changed imaging conditions from the images actually taken by the imaging unit. For example, “NO NEED” is set to the parameter of averaging number. When the averaging number is changed, the image S/N is also changed. However, in the case of the change in the S/N ratio, simulation is possible. This means that when only the averaging number condition is changed, it is possible to acquire images for the images acquired with given imaging conditions by simulation, without actually taking images by the imaging unit.

Then, based on the parameter candidate list shown in FIG. 12, the standard imaging conditions are determined as the base of the imaging condition generation. At this time, the values of the parameters with “NEED” for the image acquisition are set in advance. More specifically, the values of the acceleration voltage, the probe current, and the filed of view size are set in advance. On the other hand, the parameters with “NO NEED” for the image acquisition, namely, the averaging number and the image size, are set to a value as large as possible. For example, as shown in FIG. 12, the averaging number is set to 16 which is the largest value in the list of parameter setting value candidates. Similarly, the image size is set to 1448 pixels which is the largest value in the list shown in FIG. 12. When the image data is acquired with such largest values, it is possible to easily generate image data with the other conditions by simulation.

The process flow will be described with reference to the flow chart shown in FIG. 11. First, the process acquires evaluation defect image data in the imaging unit 101 under the standard imaging conditions (S1101). Next, similarly to the first embodiment, the process instructs the location of the defect position through the display screen shown in FIG. 6, with respect to the acquired images (S1102). Then, the process sets a plurality of imaging conditions by combining the candidate values for each of the parameters shown in FIG. 12 (S1103). Next, the process selects one of the set imaging conditions (S1104). Then, under the selected condition, the process performs image acquisition by the imaging unit 101 or image generation by simulation.

Here, the determination between the image acquisition and the image simulation (S1105) is made by the following steps.

Step 1: Acquire the type of parameter in which the setting value is different between the currently selected imaging condition and the reference imaging condition. The number of parameter types is not necessarily one and may be two or more.

Step 2: Acquire the content of “need or no need for image acquisition” corresponding to the parameter extracted in Step 1 from the table shown in FIG. 12.

Step 3: Perform image simulation if there is no parameter with “NEED” for “need or no need for the image acquisition” as a result of Step 2, or otherwise perform image acquisition by the imaging unit.

In the case shown in FIG. 12, for example, when the acceleration voltage change is included in the imaging condition parameter extracted in Step 1, it is necessary to perform image acquisition by the imaging unit 101. On the other hand, when one parameter of averaging number or image size is extracted, or when two parameters of both averaging number and image size are extracted, image simulation is performed.

The procedure of the image simulation process (S1106) will be described below. First, the image simulation procedure for the averaging number is as follows. In this case, reducing the averaging number means reducing the S/N ratio. When the signal (S) is set constant, the noise (N) increases. In other words, it is possible to generate images by simulation with a smaller value for the averaging number, by performing a process of adding random noise to the acquired reference image.

There is a statistical relationship between the averaging number and S/N. That is, when the averaging number is doubled, S/N is improved √2 times. Thus, using this relationship, the S/N of desired simulation images is obtained based on the S/N value calculated from the reference image and on the number of the specified averaging number. Then, the amount of noise to be added by the simulator 1005 is controlled to actually acquire the desired images. Further, in the case of the simulation with respect to the image size, for example, images of 1024 and 724 pixels are generated by thinning the standard image (1448 pixels in image size). It is a matter of importance for the thinning process to keep the image S/N unchanged before and after thinning of the reference image.

On the other hand, when it is determined that it is necessary to take images by the imaging unit 101 for the image acquisition under the selected imaging condition, the image acquisition is actually performed with the particular imaging condition (S1107). Probably, the field of view of such reacquired images is different from the field of view of the defect images to which the instruction data have been set. Thus, similarly to the method described in the first embodiment, the displacement of the field of view is detected by pattern matching. Then, the defect position is identified on the acquired images by adding the value of the displacement to generate the instruction data.

In the case of the image simulation, displacement of the field of view does not occur. Thus, the instruction result for the reference image directly represents the instruction result of the image simulation results. In the process flow of FIG. 11, the steps 1109 to S1112 after S1106 and S1108 are the same as the steps S4 to S7 according to the first embodiment described with reference to FIG. 4.

As described above, instead of acquiring all the image data sets with different imaging conditions by the imaging unit 101, the image simulation can also be performed depending on the types of parameters to be changed in order to improve the efficiency of the image set generation. In a low volume high mix production line, there are many types of recipes to be generated. Thus, the reduction in the image acquisition time for generating one recipe has great influence on such a production. As the most significant case, when only the conditions allowing image simulation, namely, only the parameters of addition number and image size are changed, there is no need to perform image acquisition. As a result, the evaluation image data can be generated off-line in a location separated from the imaging unit 101, for example, in another terminal connected to a network.

### Third Embodiment

Next, a third embodiment of the defect observation method according to the present invention will be described. In the first and second embodiments described above, the instruction process only instructs the location of the defect position for the defect image data set for evaluation. The third embodiment is different from the first and second embodiments in that the other defect information is also set in addition to the defect position.

In the instruction process screen described above with reference to FIG. 6, a defect information input unit 606 is an area for inputting various types of defect information. In registration of the position of a defect in the defect information input unit 606, the operator can input and register one or more pieces of information about the defect, such as type (adhesion of foreign matter, short circuiting, and the like), size, surface unevenness, and image brightness, or other characteristics of the defect.

By providing the defect information other than the defect position with respect to each defect, the operator can set imaging conditions suitable for the automatic defect image acquisition according to the attributes of the defect. For example, it is possible to classify the evaluation sample by the defect type and the defect size, and evaluate the relationship between the imaging conditions and the performance indexes (the capture rate and the throughput) for each classification result. For example, in the case of the defect size, it is possible that defects are divided into two classes based on a certain size (for example, 1 micrometer) to be able to set imaging conditions suitable for each defect class. For example, when the defect size is large, in general, the defect detection by imaging process is easy. Thus, with respect to the class of defects with a defect size larger than the standard value, there is a low risk that the defect detection rate will decrease, even with a high throughput condition such as small averaging number or small image size. On the other hand, the smaller the size of the defect the more difficult the defect detection becomes. Thus, with respect to the class of defects with a defect size less than the standard value, the imaging conditions should be selected taking into account that the capture rate is not likely to be reduced, namely, in which the throughput is sacrificed, so as to be suitable for the image acquisition of this class.

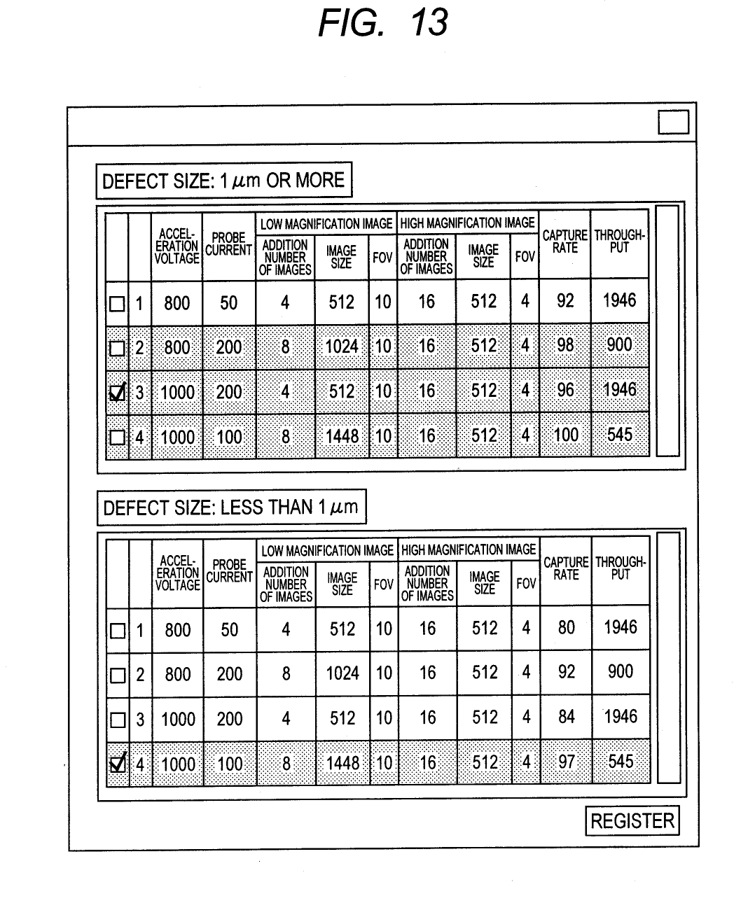

As described above, the capture rate and the throughput for each defect class are evaluated, and the results are displayed on the screen as shown in FIG. 13. The upper side of the figure shows the evaluation result of the imaging conditions for the defect size of 1 μm or more. The lower side shows the evaluation result of the imaging conditions for the defect size of less than 1 μm. In both of the results, each imaging condition with the same number has the same content.

The easiness of the defect detection is different depending on whether the defect size is large or small. When the defect size is large, 95% of the capture rate is achieved with three conditions (conditions 2, 3, 4) of the four conditions. In this case, the maximum throughput is 2250. On the other hand, when the defect size is small, only the condition 4 can be selected to achieve 95% of the capture rate. In this case, the throughput is as low as 780.

The defect inspection device has the function of identifying the position of a defect as well as outputting the approximate size of the defect. Thus, from this result, it is possible to set imaging conditions suitable for the automatic image acquisition according to the defect size of each defect. Some defect inspection devices have the function of outputting the defect size as well as the automatic defect classification result. In this case, the imaging conditions can be changed by not only the defect size but also the defect type information according to the classification result.

What is claimed is:

1. A defect observation device comprising:
an imaging means to image a sample to acquire images of the sample;
an imaging condition storage means to store imaging conditions to image the sample by the imaging means; and
a control means to acquire images of a desired portion of the sample by controlling the imaging means based on the imaging conditions stored in the imaging condition storage means,
wherein the defect observation device further includes:
an image data storage means to store a plurality of images acquired by imaging a defect of a portion specified on the sample by controlling the imaging means by the control means with the plurality of imaging conditions, as well as to store the plurality of imaging conditions, and capture rate for each of the plurality of imaging conditions;
a process time data storage means to store process time data necessary for image acquisition corresponding to each of the plurality of imaging conditions, to image the defect on the sample by controlling the imaging means by the control means with the plurality of imaging conditions;
a performance evaluation means to calculate throughput performance and the capture rate in observing the defect on the sample, based on the plurality of imaging conditions stored in the image data storage means, and on the process time data necessary for image acquisition corresponding to each of the plurality of imaging conditions stored in the process time data storage means; and
a display means to display the throughput performance and capture rate calculated by the performance evaluation means, in association with the particular imaging conditions.

2. The defect observation device according to claim 1,
wherein the imaging means is a scanning electron microscope, and
wherein the plurality of imaging conditions include any of the following: image size, field of view size, addition number of frames of detected images, acceleration voltage of electron beam, and amount of beam current.

3. The defect observation device according to claim 1,
wherein the process time data includes time for driving a stage on which the sample is placed, as well as time for imaging the sample to acquire images.

4. The defect observation device according to claim 1,
wherein the image data storage means stores, in addition to the plurality of images acquired by imaging the defect on the sample by the imaging means, the defect type of the particular defect, and
wherein the performance evaluation means calculates the capture rate and the throughput performance for each defect type.

5. The defect observation device according to claim 1,
wherein the image acquisition of imaging the defect of the portion specified on the sample by controlling the imaging means by the control means, includes the steps of:
imaging an area including the specified portion of the defect on the sample with a first field of view size of the imaging means to acquire an image of the first field of view size;
detecting the defect position from the acquired image of the first field of view size; and
imaging the detected defect position with a second field of view size of the imaging means to acquire an image of the second field of view size, and
wherein the second field of view size is smaller than the first field of view size.

6. A method for observing a defect on a sample, comprising the steps of:
calculating a defect detection rate for each of imaging conditions of imaging means, based on defect position data storing image data acquired by imaging the defect on the sample by changing the imaging conditions, together with defect position information of the image data;
calculating throughput for each of the imaging conditions of the imaging means, based on process time data necessary for image acquisition corresponding to each of the imaging conditions;
displaying capture rate and throughput performance that are calculated for each imaging condition; and
observing the defect on the sample by the imaging means based on a selected imaging condition on a screen in which the capture rate and the throughput performance are displayed.

7. The defect observation method according to claim 6,
wherein the imaging means is a scanning electron microscope, and
wherein the imaging conditions of the scanning electron microscope include any of the following: image size, field of view size, addition number of frames of detected images, acceleration voltage of electron beam, and amount of beam current.

8. The defect observation method according to claim 6,
wherein the process time data includes time for driving a stage on which the sample is placed, as well as time for imaging the sample to acquire images.

9. The defect observation method according to claim 6,
wherein the image data includes, in addition to a plurality of images of the defect on the sample, information about the defect type of the particular defect, and
wherein calculating the throughput for each imaging condition is equivalent to calculating the capture rate and the throughput performance for each defect type.

10. The defect observation method according to claim 6,
wherein the acquisition of image data by imaging the defect on the sample by changing the imaging conditions of the imaging means, includes the steps of:
imaging an area including the specified portion of the defect on the sample with a first field of view size of the imaging means to acquire an image of the first field of view size;
detecting the defect position from the acquired image of the first field of view size; and
imaging the detected defect position with a second field of view size of the imaging means to acquire an image of the second field of view size,
wherein the second field of view size is smaller than the first field of view size.
